(19) United States
(12) Patent Application Publication
(10) Pub. No.: US 2020/0031360 A1
(43) Pub. Date: Jan. 30, 2020

(54) DRIVING EVALUATION SYSTEM, DRIVING EVALUATION METHOD, PROGRAM, AND MEDIUM

(71) Applicant: HONDA MOTOR CO., LTD., Tokyo (JP)

(72) Inventor: Hideyuki Suzuki, Wako-shi (JP)

(73) Assignee: HONDA MOTOR CO., LTD., Tokyo (JP)

(21) Appl. No.: 16/524,739

(22) Filed: Jul. 29, 2019

(30) Foreign Application Priority Data
Jul. 30, 2018 (JP) 2018-142092

(51) Int. Cl. B60W 40/09; G07C 5/02; B60W 30/18; B60W 10/04; B60W 50/08; B60W 10/20

(52) U.S. Cl. CPC B60W 40/09; G07C 5/02; B60W 30/18; B60W 2050/0028; B60W 50/08; B60W 10/20; B60W 10/04

(57) ABSTRACT

A driving evaluation system evaluates driving skills of a vehicle by a driver, the system including: a data acquisition unit that is configured to acquire traveling data including time series data of acceleration in a predetermined traveling scene; and an evaluation unit that is configured to calculate, on a basis of the traveling data, time series data of snap which is the second-order time differential of acceleration and evaluate driving skills in the traveling scene on a basis of time series data of snap in an evaluation target period which is a transitional period of acceleration in a recording period of the traveling data.

This application is based on and claims the benefit of priority from Japanese Patent Application No. 2018-142092, filed on 30 Jul. 2018, the content of which is incorporated herein by reference.

### BACKGROUND OF THE INVENTION

### Field of the Invention

The present invention relates to a driving evaluation system that evaluates driving skills of a vehicle by a driver, a driving evaluation method, a program, and a medium.

### Related Art

Japanese Unexamined Patent Application, Publication No. 2014-80087 discloses a driving evaluation system that evaluates driving skills of a vehicle by a driver in real time. In the driving evaluation system of Japanese Unexamined Patent Application, Publication No. 2014-80087, the driving skills of a vehicle by a driver are evaluated in real time on the basis of the comparison with a threshold that is set on the basis of a vehicle speed and a synthetic acceleration made by synthesizing longitudinal acceleration and lateral acceleration of the vehicle.

### SUMMARY OF THE INVENTION

As above, in the conventional driving evaluation systems, driving skills are often evaluated by focusing on vehicle acceleration. Therefore, in the conventional driving evaluation system, although it is possible to reflect a change in acceleration in a period in which the acceleration is supposed to become steady on evaluation of the driving skills, it is difficult to evaluate the driving skills in a transitional period of acceleration, i.e., a period for reaching from a predetermined acceleration to a target acceleration. It is possible for a driver having high driving skills to smoothly change vehicle acceleration up to the target acceleration. However, in the conventional driving evaluation system that evaluates driving skills by using vehicle acceleration, it is not possible to appropriately evaluate driving skills in a transitional period of such acceleration.

It is an object of the present invention to provide a driving evaluation system that makes it possible to evaluate driving skills in a transitional period of acceleration, a driving evaluation method, a program, and a medium.

According to a first aspect of the present invention, a driving evaluation system includes: a data acquisition unit that is configured to acquire traveling data including time series data of acceleration in a predetermined traveling scene; and an evaluation unit that is configured to calculate, on a basis of the traveling data, time series data of snap which is second-order time differential of acceleration, and evaluate driving skills in the traveling scene on a basis of time series data of snap in an evaluation target period which is a transitional period of acceleration in a recording period of the traveling data.

According to a second aspect of the driving evaluation system of the present invention, it is preferable that the evaluation unit includes a first evaluation unit that evaluates driving skills on a basis of a number of times the snap crosses a value of 0 within the evaluation target period.

According to a third aspect of the driving evaluation system of the present invention, it is preferable that the traveling data includes time series data of longitudinal acceleration and time series data of lateral acceleration; and the first evaluation unit sets, in a case in which the traveling scene is a deceleration scene or an acceleration scene, a period from a starting time period of the traveling data to a time period in which an absolute value of longitudinal acceleration becomes a maximum, as the evaluation target period, and sets, in a case in which the traveling scene is a turning scene, a period from a time period in which an absolute value of longitudinal acceleration becomes a maximum to a time period in which an absolute value of lateral acceleration becomes a maximum, as the evaluation target period.

According to a fourth aspect of the driving evaluation system of the present invention, it is preferable that the evaluation unit includes a second evaluation unit that evaluates driving skills on a basis of a maximum value of an absolute value of snap within the evaluation target period.

According to a fifth aspect of the driving evaluation system of the present invention, it is preferable that the driving evaluation system further includes an acceleration prediction model that is configured to output a prediction value for a maximum value of an absolute value of acceleration within the evaluation target period when inputting a maximum value of an absolute value of snap within the evaluation target period, in which the second evaluation unit evaluates driving skills on a basis of degree of divergence between the maximum value of the absolute value of acceleration within the evaluation target period and a prediction value calculated by using the acceleration prediction model.

According to a sixth aspect of the driving evaluation system of the present invention, it is preferable that the traveling data includes time series data of longitudinal acceleration and time series data of lateral acceleration, and the second evaluation unit: sets as the evaluation target period, in a case in which the traveling scene is a deceleration scene, a first period from a starting time period of the traveling data to a time period in which an absolute value of longitudinal acceleration becomes a maximum and a second period from a final period of the first period to an ending time period of the traveling data, and evaluates driving skills for each of the first period and the second period; sets as the evaluation target period, in a case in which the traveling scene is an acceleration scene, the first period; and sets as the evaluation target period, in a case in which the traveling scene is a turning scene, a period from a time period in which an absolute value of longitudinal acceleration becomes a maximum to a time period in which an absolute value of lateral acceleration becomes a maximum.

According to a seventh aspect of the present invention, a driving evaluation method is a method executed by the driving evaluation system according to the first aspect, and includes the steps of: acquiring, by way of the data acquisition unit, traveling data including time series data of acceleration in a predetermined traveling scene; and evaluating, by way of the evaluation unit, driving skills in the traveling scene on a basis of time series data of snap in an evaluation target period which is a transitional period of acceleration in a recording period of the traveling data, while calculating, on a basis of the traveling data, time series data of snap which is second-order time differential of acceleration.

According to an eighth aspect of the present invention, a program according to the present invention is a program for causing a computer to execute each step of the driving evaluation method according to the seventh aspect.

According to a ninth aspect of the present invention, a medium according to the present invention is a medium encoded with the program according to the eighth aspect.

According to the first aspect of the present invention, a physical quantity obtained by differentiating distance by time is velocity; a physical quantity obtained by differentiating velocity is acceleration; a physical quantity obtained by differentiating acceleration by time is jerk; and a physical quantity obtained by differentiating jerk is snap. Therefore, it can be said that, among these five physical quantities, the jerk is a physical quantity that is particularly suited for evaluating a minute change of acceleration in a steady state of the acceleration, and the snap is a physical quantity that is particularly suited for evaluating a minute change of acceleration in a transitional period of the acceleration. Therefore, the driving evaluation system according to the present invention acquires, by way of the data acquisition unit, traveling data including time series data of acceleration in a predetermined traveling scene, and evaluates, by way of the evaluation unit, driving skills in the traveling scene on a basis of time series data of snap in an evaluation target period which is a transitional period of acceleration in a recording period of the traveling data, while calculating, on a basis of the traveling data, time series data of snap which is second-order time differential of acceleration. With such a configuration, it is possible to evaluate driving skills in a transitional period of acceleration in a traveling scene by using snap which is a physical quantity that is suited for evaluating the driving skills.

According to the second aspect of the present invention, the snap is obtained by performing second-order time differential on acceleration. As such, if the change of acceleration in the transitional period is unstable, it is assumed that the snap in the period crosses the value of 0. Therefore, the first evaluation unit evaluates the driving skills on the basis of the number of times the snap crosses the value of 0 within the evaluation target period, thereby making it possible to evaluate acceleration continuity in the transitional period of acceleration.

According to the third aspect of the present invention, in a case in which the traveling scene is a deceleration scene or an acceleration scene, the first evaluation unit sets a period from a starting time period of the traveling data to a time period in which an absolute value of longitudinal acceleration becomes a maximum, as the evaluation target period, and sets, in a case in which the traveling scene is a turning scene, a period from a time period in which an absolute value of longitudinal acceleration becomes a maximum to a time period in which an absolute value of lateral acceleration becomes a maximum, as the evaluation target period. According to the present invention, it is possible to appropriately evaluate driving skills for each traveling scene by changing the evaluation target period for performing evaluation by using the snap by the first evaluation unit in accordance with the kind of traveling scene.

According to the fourth aspect of the present invention, the second evaluation unit evaluates driving skills on the basis of a maximum value of an absolute value of snap within an evaluation target period, thereby making it possible to finely evaluate driving skills in a traveling scene.

According to the fifth aspect of the present invention, the second evaluation unit evaluates driving skills on the basis of degree of divergence between a maximum value of an absolute value of acceleration within an evaluation target period and a prediction value of acceleration acquired by inputting a maximum value of an absolute value of snap within the evaluation target period into an acceleration prediction model. This makes it possible to finely evaluate driving skills in a traveling scene.

According to the sixth aspect of the present invention, the second evaluation unit sets, in a case in which a traveling scene is a deceleration scene, a first period from a starting time period of traveling data to a time period in which an absolute value of longitudinal acceleration becomes a maximum and a second period from a final time period of the first period to an ending time period of the traveling data, as an evaluation target period, and evaluates driving skills for each of the first period and the second period; sets as the evaluation target period, in a case in which the traveling scene is an acceleration scene, the first period; and sets as the evaluation target period, in a case in which the traveling scene is a turning scene, a period from a time period in which an absolute value of longitudinal acceleration becomes a maximum to a time period in which an absolute value of lateral acceleration becomes a maximum. According to the present invention, it is possible to appropriately evaluate driving skills for each traveling scene by changing the evaluation target period for performing evaluation by using the snap by the second evaluation unit in accordance with the kind of traveling scene.

### BRIEF DESCRIPTION OF THE DRAWINGS

FIG. 1 is a diagram illustrating a configuration of a vehicle equipped with a driving evaluation system according to an embodiment of the present invention;

FIG. 2 is a graph illustrating an example of evaluation target data extracted by a scene extraction unit;

FIG. 3 is a graph illustrating an example of in-turn data acquired by an in-turn data acquisition unit;

FIG. 4 is a table compiling evaluation methods of driving skills for each traveling scene by a driving skills evaluation unit;

FIG. 5A is a graph illustrating an example of time series data of a longitudinal acceleration value, a lateral acceleration value, and a jerk vector value in a deceleration scene (in a case in which the driver is an expert driver);

FIG. 5B is a graph illustrating an example of time series data of a longitudinal acceleration value, a lateral acceleration value, and a jerk vector value in a deceleration scene (in a case in which the driver is a normal driver);

FIG. 6A is a graph illustrating an example of in-turn data acquired by the in-turn data acquisition unit;

FIG. 6B is a diagram in which an actual traveling trajectory of a vehicle when the in-turn data in FIG. 6A is acquired is plotted on a road map;

FIG. 7A is a graph illustrating time series data, etc., of longitudinal acceleration and lateral acceleration included in the in-turn data (in a case in which the driver is an expert driver);

FIG. 7B is a graph illustrating time series data, etc., of longitudinal acceleration and lateral acceleration included in the in-turn data (in a case in which the driver is a normal driver);

FIG. 8A is a diagram in which an acceleration vector included in the in-turn data of FIG. 7B is plotted on a two-dimensional plane with the longitudinal acceleration as a vertical axis and the lateral acceleration as a horizontal axis;

FIG. 8B is a diagram in which an acceleration vector included in the in-turn data of FIG. 7A is plotted on a two-dimensional plane with the longitudinal acceleration as a vertical axis and the lateral acceleration as a horizontal axis;

FIG. 9 is a diagram of a configuration of a snap evaluation unit;

FIG. 10A is a graph illustrating an example of time series data of longitudinal snap and lateral snap included in snap data of a deceleration scene in a case in which a driver is an expert driver;

FIG. 10B is a graph illustrating an example of time series data of longitudinal snap and lateral snap included in snap data of a deceleration scene in a case in which a driver is a normal driver;

FIG. 11A is a graph illustrating an example of time series data of longitudinal snap and lateral snap included in snap data of a turning scene in a case in which a driver is an expert driver;

FIG. 11B is a graph illustrating an example of time series data of longitudinal snap and lateral snap included in snap data of a turning scene in a case in which a driver is a normal driver; and

FIG. 12 is a flowchart illustrating a specific procedure for evaluating driving skills of a driver in the driving evaluation system.

### DETAILED DESCRIPTION OF THE INVENTION

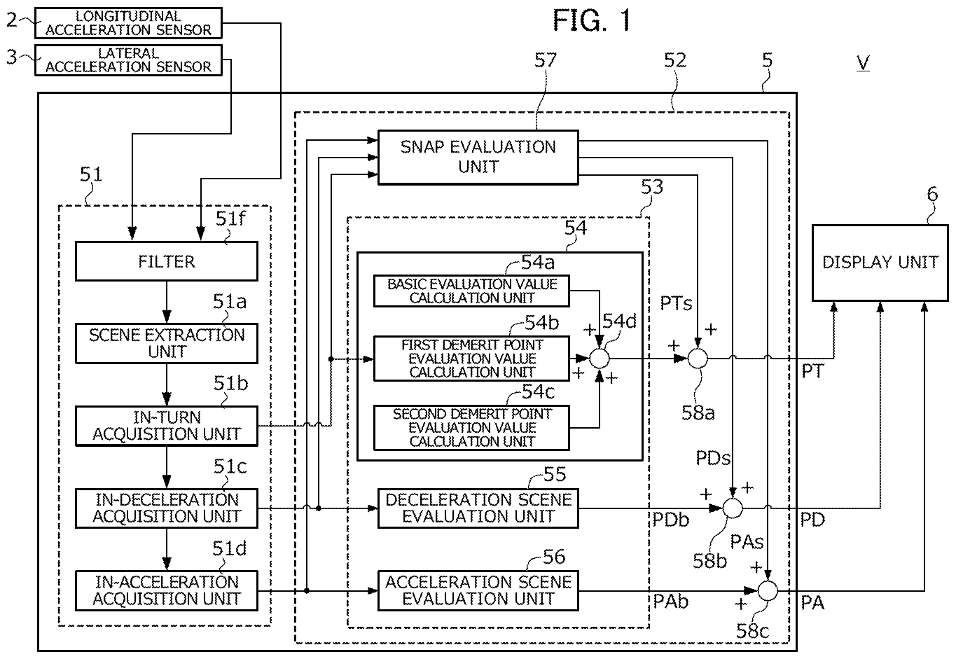

Hereinafter, an embodiment of the present invention will be described with reference to the drawings. FIG. 1 is a diagram illustrating a configuration of a vehicle V equipped with a driving evaluation system 1 according to the present embodiment.

The driving evaluation system 1 includes: a longitudinal acceleration sensor 2 that detects longitudinal acceleration along a traveling direction of a vehicle V; a lateral acceleration sensor 3 that detects lateral acceleration along a width direction of the vehicle V; an ECU (Electronic Control Unit) 5 that evaluates driving skills of the vehicle V by a driver on the basis of detection signals of these acceleration sensors 2 and 3; and a display unit 6 that displays evaluation results of the driving skills by the ECU 5 in a manner that is visually recognizable to the driver, or the like.

The longitudinal acceleration sensor 2 is attached to the body of the vehicle V, detects the longitudinal acceleration along the traveling direction of the vehicle V; and transmits a signal corresponding to a detection value to the ECU 5. For the longitudinal acceleration sensor 2, for example, a uniaxial acceleration sensor is used which is attached to the vehicle body in such a manner that the detection axis of the uniaxial acceleration sensor is in parallel with the traveling direction. It should be noted that, hereinafter, a case will be description in which the detection value of the longitudinal acceleration sensor 2 becomes positive upon deceleration of the vehicle V and becomes negative upon acceleration of the vehicle V; however, the present invention is not limited thereto.

The lateral acceleration sensor 3 is attached to the body of the vehicle V, detects the lateral acceleration along the width direction that is perpendicular to the traveling direction, and transmits a signal corresponding to the detection value to the ECU 5. For the lateral acceleration sensor 3, for example, a uniaxial acceleration sensor is used which is attached to the vehicle body in such a manner that a detection axis of the uniaxial acceleration sensor is in parallel with the width direction. It should be noted that, hereinafter, a case is described in which the detection value of the lateral acceleration sensor 3 becomes positive upon deceleration of the vehicle V and becomes negative upon acceleration of the vehicle V; however, the present invention is not limited thereto.

The ECU 5 is an on-vehicle computer that is configured by a CPU, ROM, RAM, a data bus, an input/output interface, etc. The ECU 5 executes various kinds of arithmetic processing in the CPU in accordance with programs stored in the ROM, thereby functioning as a data acquisition unit 51 and a driving skills evaluation unit 52 as described below.

The data acquisition unit 51 uses the detection signals that are transmitted from the longitudinal acceleration sensor 2 and the lateral acceleration sensor 3 during traveling of the vehicle V, thereby generating time series data of the longitudinal acceleration and the lateral acceleration during traveling. More specifically, the data acquisition unit 51 includes a filter 51f, a scene extraction unit 51a, an in-turn data acquisition unit 51b, an in-deceleration data acquisition unit 51c, and an in-acceleration data acquisition unit 51d, and uses these to thereby generate the time series data.

The filter 51f performs filter processing for the detection values from the longitudinal acceleration sensor 2 and the lateral acceleration sensor 3 in order to remove high frequency noise therefrom, and transmits a resultant filter value to the scene extraction unit 51a. Here, more specifically, a weighted moving average is used for the filter processing, for example. It should be noted that, in the following, a filter value of the detection value from the longitudinal acceleration sensor 2 obtained through the filter 51f is denoted as XG, and a filter value of the detection value of the lateral acceleration sensor 3 obtained through the filter 51f is denoted as YG.

The scene extraction unit 51a extracts, as evaluation target data, the time series data as an evaluation target in the driving evaluation system 1 among the time series data of the longitudinal acceleration and the lateral acceleration obtained from the longitudinal acceleration sensor 2 and the lateral acceleration sensor 3 through the filter 51f during the traveling of the vehicle V. More specifically, the scene extraction unit 51a uses the longitudinal acceleration value XG and the lateral acceleration value YG to calculate, at each point of time, an acceleration vector value VG having the longitudinal acceleration and the lateral acceleration as its components in accordance with the following expression (1), and extracts the evaluation target data by using the acceleration vector value VG.

VG=(XG²+YG²)^{1/2} (1)

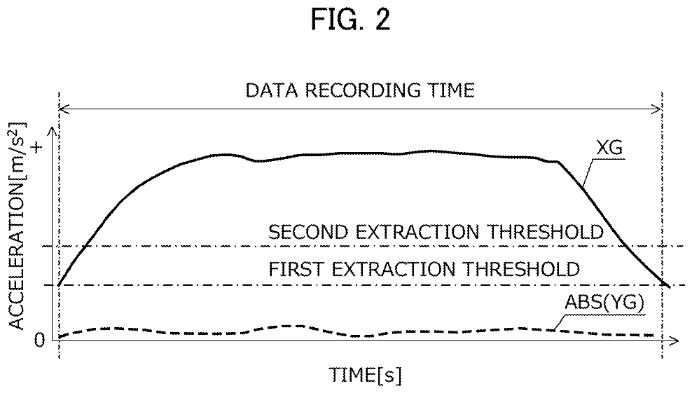

FIG. 2 is a graph illustrating an example of evaluation target data extracted by the scene extraction unit 51a. It should be noted that FIG. 2 illustrates the longitudinal acceleration value XG and an absolute value ABS (YG) of the lateral acceleration value YG. It should be noted that the acceleration vector value VG mostly overlaps with the longitudinal acceleration value XG. Therefore, the illustration is omitted in FIG. 2.

The scene extraction unit 51a extracts, as evaluation target data, time series data which satisfy all of the following three conditions (a), (b), and (c) from among the time series data of the longitudinal acceleration and the lateral acceleration transmitted from the longitudinal acceleration sensor 2 and the lateral acceleration sensor 3. The scene extraction unit 51a generates, as the evaluation target data, the time series data that satisfy the following conditions, to thereby make it possible to extract only data that are worth evaluating the driving skills from among many pieces of data transmitted from the longitudinal acceleration sensor 2 and the lateral acceleration sensor 3.

(a) The acceleration vector value VG is equal to or more than a first extraction threshold (for example, 0.6 [m/s²]).
(b) Data recording time indicating the length of evaluation target data is at least 5 seconds and within 15 seconds.
(c) The average value AVE(VG) of the acceleration vector value VG is equal to or more than a second extraction threshold (for example, 1 [m/s²]).

The data acquisition unit 51 divides the evaluation target data that are extracted by the scene extraction unit 51a into three types of a turning scene, a deceleration scene, and an acceleration scene, and generates the time series data for each scene.

The in-turn data acquisition unit 51b acquires evaluation target data that satisfy a predetermined condition from among the evaluation target data extracted by the scene extraction unit 51a, as the in-turn data including the time series data of the longitudinal acceleration and the lateral acceleration in the turning scene.

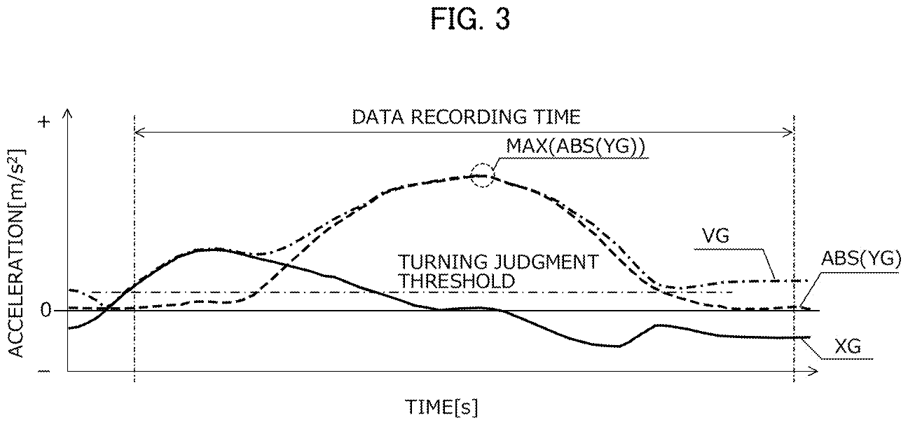

FIG. 3 is a graph illustrating an example of the in-turn data acquired by the in-turn data acquisition unit 51b. The in-turn data acquisition unit 51b calculates the maximum value MAX (ABS(YG)) of the absolute value ABS(YG) of the lateral acceleration value YG included in the evaluation target data extracted by the scene extraction unit 51a, and in a case in which the maximum value MAX (ABS(YG)) is equal to or more than a predetermined turning judgment threshold (for example, 1 [m/s²]), the in-turn data acquisition unit 51b acquires the evaluation target data as the in-turn data.

Therefore, turning scene in the present embodiment refers to a section in which a state having an acceleration vector value VG equal to or more than the first extraction threshold continues for at least 5 seconds and within 15 seconds, the average value AVE(VG) of the acceleration vector is equal to or more than the second extraction threshold, and the maximum value MAX (ABS(YG)) of the lateral acceleration is equal to or more than the turning judgment threshold.

The in-deceleration data acquisition unit 51c acquires, as in-deceleration data including the time series data of the longitudinal acceleration and the lateral acceleration in the deceleration scene, evaluation target data that satisfy a predetermined condition from among evaluation target data in which the in-turn data is subtracted from the evaluation target data extracted by the scene extraction unit 51a. More specifically, the in-deceleration data acquisition unit 51c calculates the average value AVE(XG) of the longitudinal acceleration value XG included in the evaluation target data from which the in-turn data is excluded and, in a case in which the average value (AVE(XG)) is 0 m/s², the in-deceleration data acquisition unit 51c acquires the evaluation target data as the in-deceleration data.

Therefore, deceleration scene in the present embodiment is a traveling scene that is different from the turning scene, and refers to a section in which a state having an acceleration vector value VG equal to or more than the first extraction threshold continues for at least 5 seconds and within 15 seconds, the average value AVE(VG) of the acceleration vector is equal to or more than the second extraction threshold, and the average value AVE(XG) of the longitudinal acceleration is more than 0.

The in-acceleration data acquisition unit 51d acquires, as in-acceleration data including the time series data of the longitudinal acceleration and the lateral acceleration in the acceleration scene, data in which the in-turn data and the in-deceleration data are subtracted from the evaluation target data extracted from the scene extraction unit 51a.

Therefore, the acceleration scene in the present embodiment is a traveling scene that is different from the turning scene, and refers to a section in which a state having an acceleration vector value VG equal to or more the first extraction threshold continues for at least 5 seconds and within 15 seconds, the average value AVE(VG) of the acceleration vector is equal to or more than the second extraction threshold, and the average value AVE(XG) of the longitudinal acceleration is equal to or less than 0.

The driving skills evaluation unit 52 evaluates the driving skills in each traveling scene on the basis of the evaluation target data (the in-turn data, the in-deceleration data, and the in-acceleration data) acquired by the data acquisition unit 51 as described above.

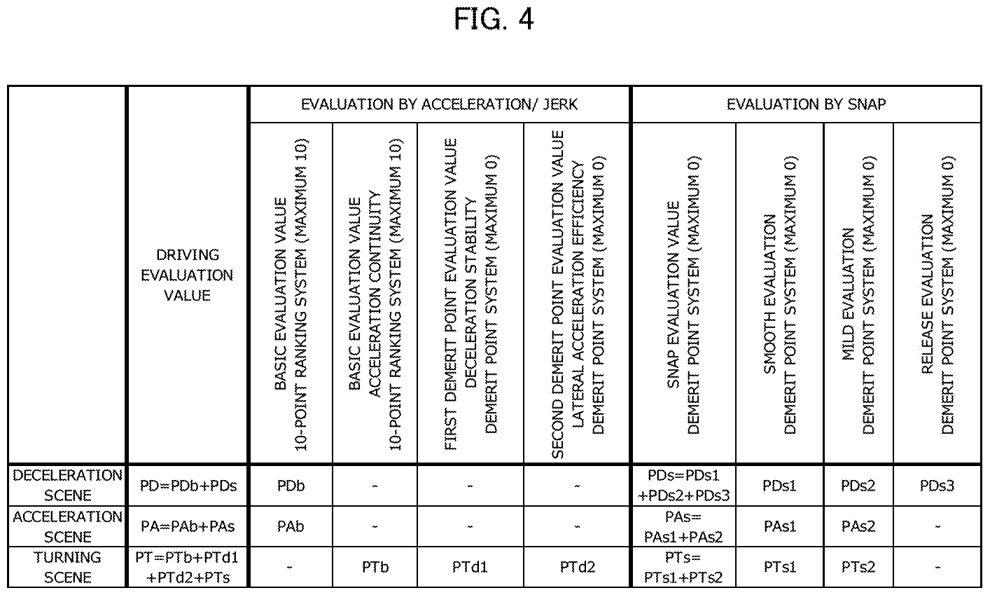

FIG. 4 is a table compiling evaluation methods of driving skills for each traveling scene by driving skills evaluation unit 52. The driving skills evaluation unit 52 evaluates the driving skills in the deceleration scene by a driving evaluation value PD, evaluates the driving skills in the acceleration scene by a driving evaluation value PA, and evaluates the driving skills in the turning scene by a driving evaluation value PT. As illustrated in FIG. 4, the driving skills evaluation unit 52 evaluates the driving skills in each traveling scene with the driving evaluation values PD, PA, and PT, which are quantified with a positive real number of no more than 10. It should be noted that these driving evaluation values indicate that the evaluation of driving skills is higher with a larger value.

More specifically, the driving skills evaluation unit 52 includes: an acceleration/jerk evaluation unit 53 that evaluates the driving skills in each traveling scene mainly on the basis of acceleration and jerk; a snap evaluation unit 57 that evaluates the driving skills in each traveling scene mainly on the basis of acceleration and snap; and comprehensive evaluation units 58a, 58b, and 58c that calculate the driving evaluation values PT, PD, and PA in each traveling scene by combining the evaluation from the acceleration/jerk evaluation unit 53 and the evaluation from the snap evaluation unit 57. As illustrated in FIG. 4, the acceleration/jerk evaluation unit 53 evaluates the driving skills in each traveling scene with basic evaluation values PDb, PAb, and PTb, which are quantified with positive real numbers of no more than 10, and the driving skills in the turning scene with demerit point evaluation values PTd1 and PTd2, which are quantified with negative real numbers having 0 as a maximum value. Further, the snap evaluation unit 57 evaluates the driving skills in each traveling scene with snap evaluation values PDs, PAs, and PTs, which are quantified with negative real numbers having 0 as a maximum value. In the following, specific procedures of the acceleration/jerk evaluation unit 53, the snap evaluation unit 57, and the comprehensive evaluation units 58a, 58b, and 58c are described.

With reference to FIG. 1 again, the acceleration/jerk evaluation unit 53 includes the turning scene evaluation unit 54 that evaluates the driving skills in the turning scene mainly on the basis of acceleration and jerk, the deceleration scene evaluation unit 55 that evaluates the driving skills in the deceleration scene mainly on the basis of acceleration and jerk, and the acceleration scene evaluation unit 56 that evaluates the driving skills in the acceleration scene mainly on the basis of acceleration and jerk. In the following, specific evaluation procedures of the respective evaluation units 54, 55, and 56 are described.

The deceleration scene evaluation unit 55 calculates, under a 10-point ranking system, the basic evaluation value PDb prepared by quantifying the driving skills of a driver in the deceleration scene which is specified by in-deceleration data on the basis of the in-deceleration data acquired by the in-deceleration data acquisition unit 51c. More specifically, the deceleration scene evaluation unit 55 calculates the basic evaluation value PDb of the deceleration scene by using time series data of the acceleration vector value VG acquired by the in-deceleration data or time series data of the jerk vector value VJ indicated by the following expression (2). Here, jerk vector refers to a vector having longitudinal jerk and lateral jerk as components. It is possible to calculate the time series data of the jerk vector value VJ by applying time differential to each of the longitudinal acceleration value XG and the lateral acceleration value YG included in the in-deceleration data to compute a longitudinal jerk calculated value XJ and a lateral jerk calculated value YJ, thereby performing calculation with the following expression (2) using these calculated values XJ and YJ.

VJ=(XJ²+YJ²)^{1/2} (2)

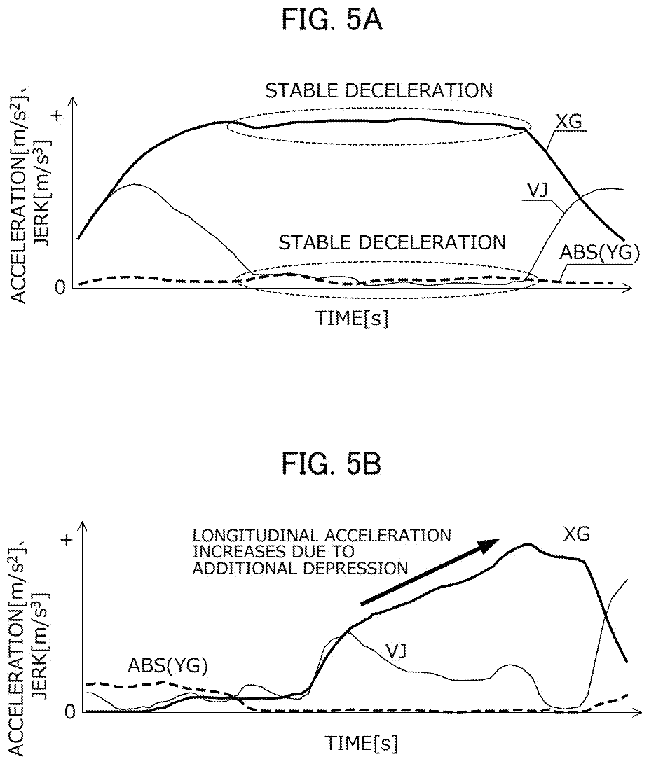

FIGS. 5A and 5B are each a graph illustrating an example of time series data of a longitudinal acceleration value XG, a lateral acceleration value YG, and a jerk vector value VJ in a deceleration scene. More specifically, FIG. 5A illustrates an example of time series data in a case in which the driver is an expert driver, and FIG. 5B illustrates an example of time series data in a case in which the driver is a normal driver.

In a deceleration scene in which the vehicle speed is decelerated during a target period of time from a predetermined speed to a target speed, it is generally preferable for the amount of depressing the brake pedal to be constant. Since the expert driver can decelerate the vehicle as he/she wishes to the target speed during the target period of time without substantially changing the amount of depressing the brake pedal during the deceleration of the vehicle, as illustrated in FIG. 5A, in the deceleration scene, a period of time in which the longitudinal acceleration value XG and the acceleration vector value VG become constant is long. Therefore, the jerk vector value VJ becomes in a convex shape at the deceleration start time as illustrated in FIG. 5A. However, thereafter, the value VJ becomes constant in the vicinity of 0.

In contrast, the normal driver cannot decelerate the vehicle as he/she wishes during the target period of time, and may further depress the brake pedal at the final period of the deceleration. For this reason, as illustrated in FIG. 5B, the period of time in which the longitudinal acceleration value XG becomes constant in the deceleration scene is short as compared to the period of time by the expert driver. Therefore, the jerk vector value VJ transitions to deviate from 0, as illustrated in FIG. 5B.

In view of the above, it can be recognized as appropriate for the driving skills of the driver in the deceleration scene to be evaluated by using the acceleration vector value VG or the jerk vector value VJ that is obtained by the in-deceleration data.

Incidentally, it is preferable for the evaluation value of the driving skills to be uniquely defined only by the driver's driving skills irrespective of whether it is during driving at a high speed or low speed. However, the acceleration vector value VG and the jerk vector value VJ may change, even if the same driver, depending on whether it is during driving at a high speed or low speed. For example, there is a tendency of the change in the acceleration vector value VG and the jerk vector value VJ becoming larger during driving at a high speed than during driving at a low speed. Therefore, the deceleration scene evaluation unit 55 calculates the driving evaluation value PD on the basis of the ratio of the acceleration vector value VG to the maximum value MAX(VG) of the acceleration vector value over the recording time of the in-deceleration data, or the ratio of the jerk vector value VJ to the maximum value MAX(VJ) of the jerk vector value over the recording time of the in-deceleration data. In the following, an evaluation procedure using the ratio of the acceleration vector and an evaluation procedure using the ratio of the jerk vector are described sequentially.

In a case of performing evaluation using the ratio of the acceleration vector, the deceleration scene evaluation unit 55 divides the recording time of the in-deceleration data into N points (N is an integer equal to or more than 2), acquires an acceleration vector value VG(i) (i is an integer from 1 to N) at each point of time, and further calculates the maximum value MAX(VG) of the acceleration vector value VG over the recording time of the in-deceleration data. In addition, the deceleration scene evaluation unit 55 calculates the ratio (VG(i)/MAX(VG)) of the acceleration vector value VG(i) at each point of time to the maximum value MAX(VG), and further calculates an average value of these ratios (VG(1)+VG(2)+ . . . +VG(N))/MAX(VG)/N. The average value calculated as described above tends to approach 1 as the change in the acceleration vector value VG becomes smaller, and tends approach 0 as the change in the acceleration vector value VG becomes larger. Therefore, the deceleration scene evaluation unit 55 sets a value calculated by multiplying the average value by a value 10 as the basic evaluation value PDb. This makes it possible to calculate the basic evaluation value PDb by means of the 10-point ranking system.

Furthermore, in a case of performing an evaluation using the ratio of the jerk vector, the deceleration scene evaluation unit 55 divides the recording time of the in-deceleration data into M points (M is an integer equal to or more than 2), acquires a jerk vector value VG(j) (j is an integer from 1 to M) at each point of time, and further calculates the maximum value MAX(VJ) of the jerk vector value VJ over the recording time of the in-deceleration data. In addition, the deceleration scene evaluation unit 55 calculates the ratio (VJ(j)/MAX(VJ)) of the jerk vector value VJ(j) at each point of time to the maximum value MAX(VJ), and further calculates an average value of these ratios (VJ(1)+VJ(2)+ . . . +VJ(M))/MAX(VJ)/M. The average value calculated as described above tends to approach 0 as the jerk vector value VJ(j) at each point of time comes closer to 0, and tends to become larger than 0 as the jerk vector value VJ(j) at each point of time distances from the value 0 to become larger. Therefore, the deceleration scene evaluation unit 55 performs a predetermined normalization processing on the average value calculated as above to thereby calculate the basic evaluation value PDb for the deceleration scene. The normalization processing here refers to processing of converting the above-described average value into the driving evaluation value PDb so that the basic evaluation value PDb approaches 10, which is the maximum points as the average value approaches 0, and the driving evaluation value PDb becomes smaller as the average value becomes larger.

The acceleration scene evaluation unit 56 calculates, under the 10-point ranking system, the basic evaluation value PAb prepared by quantifying the driving skills of the driver in the acceleration scene specified by the in-acceleration data on the basis of the in-acceleration data acquired by the in-acceleration data acquisition unit 51d. It should be noted that the acceleration scene differs from the deceleration scene in that the sign for the longitudinal acceleration value becomes opposite; however, it is basically possible to calculate the basic evaluation value PAb under the 10-point ranking system by using the acceleration vector value VG or the jerk vector value VJ, similarly to the case of the deceleration scene. Therefore, explanations will be omitted hereinafter for descriptions of a specific procedure for calculating the basic evaluation value PAb in the acceleration scene evaluation unit 56.

The turning scene evaluation unit 54 calculates the evaluation value PTb, PTd1, and PTd2 prepared by quantifying the driving skills of the driver in the turning scene specified by the in-turn data on the basis of the in-turn data acquired by the in-turn data acquisition unit 51b.

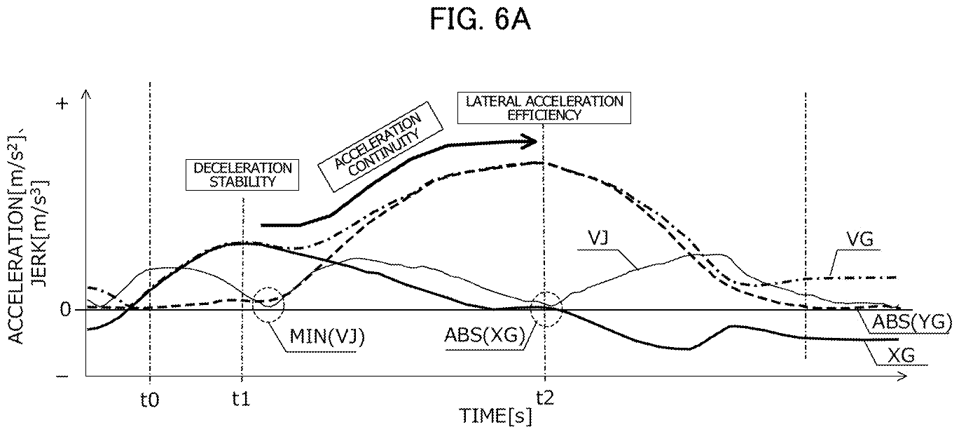

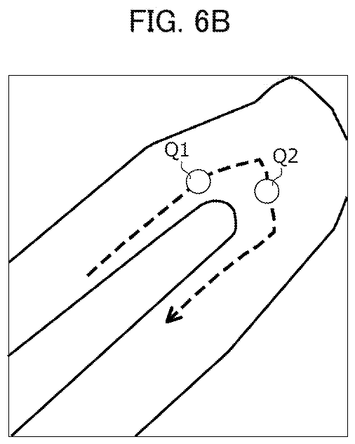

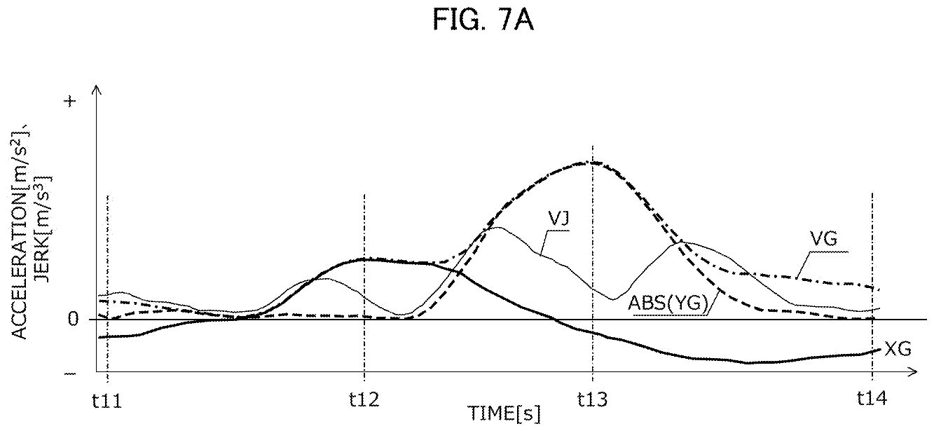

FIG. 6A is a graph illustrating an example of the in-turn data acquired by the in-turn data acquisition unit 51b. FIG. 6B is a diagram in which an actual traveling trajectory of the vehicle V when the in-turn data in FIG. 6A is acquired is plotted on a road map. It should be noted that FIG. 6A illustrates not only the time series data of the longitudinal acceleration value XG and the lateral acceleration value YG included in the in-turn data, but also time series data of the acceleration vector value VG and the jerk vector value VJ that are calculated by using these values XG and YG.

As illustrated in FIG. 6A, generally speaking, during turning of a vehicle, the driver decelerates the vehicle V by depressing the brake pedal during the time t0 to the vicinity of time t1, turns the vehicle V by starting a steering manipulation from the vicinity of the time t1 at which the longitudinal acceleration becomes a maximum, and thereafter, accelerates the vehicle V by starting depressing of the accelerator pedal in the vicinity of the time t2 at which the absolute value of the lateral acceleration becomes a maximum. In FIG. 6B, the position of the vehicle V at the time t1 is denoted by the circle Q1, and the position of the vehicle V at the time t2 is denoted by the circle Q2.

The turning scene evaluation unit 54 evaluates driving skills in a turning scene by comprehensively evaluating deceleration stability indicating the stability of acceleration at the time of starting the steering manipulation in the vicinity of time t1 in FIG. 6A, lateral acceleration efficiency indicating the stability of acceleration at the time of ending the turning and transitioning to the acceleration in the vicinity of time t2 in FIG. 6A, and acceleration continuity indicating the stability of continuity of the acceleration from the longitudinal direction to the lateral direction realized between time t1 and time t2 (refer to FIG. 4).

More specifically, the turning scene evaluation unit 54 includes: a basic evaluation value calculation unit 54a for calculating a basic evaluation value PTb in which the acceleration continuity is quantified by a positive real number of no more than 10; a first demerit point evaluation value calculation unit 54b for calculating a first demerit point evaluation value PTd1 in which the deceleration stability is quantified by a negative real number with 0 as the maximum value and about −1 as the minimum value; a second demerit point evaluation value calculation unit 54c for calculating a second demerit point evaluation value PTd2 in which the lateral acceleration efficiency is quantified by a negative real number with 0 as the maximum value and about −1 as the minimum value; and a summing unit 54d for quantifying the driving skills of the driver in the turning scene by a positive real number of no more than 10 by summing these evaluation values PTb, PTd1, and PTd2.

As illustrated in FIG. 4, the turning scene evaluation unit 54 evaluates the acceleration continuity under the 10-point ranking system, and evaluates the deceleration stability and the lateral acceleration efficiency under a demerit point system. The basic evaluation value PTb may have a value of about 0 to 10, which is larger than the values (about −1 to 0) that the first demerit point evaluation value PTd1 and the second demerit point evaluation value PTd2 may have. That is, the turning scene evaluation unit 54 evaluates the driving skills in the turning scene with weight larger than the deceleration stability and the lateral acceleration efficiency with respect to the acceleration continuity that is particularly apt to cause a difference in level of the driving skills among the acceleration continuity, the deceleration stability, and the lateral acceleration efficiency. Hereinafter, specific procedures for calculating the evaluation values PTb, PTd1, and PTd2 in the respective evaluation value calculation units 54a, 54b, and 54c will be described.

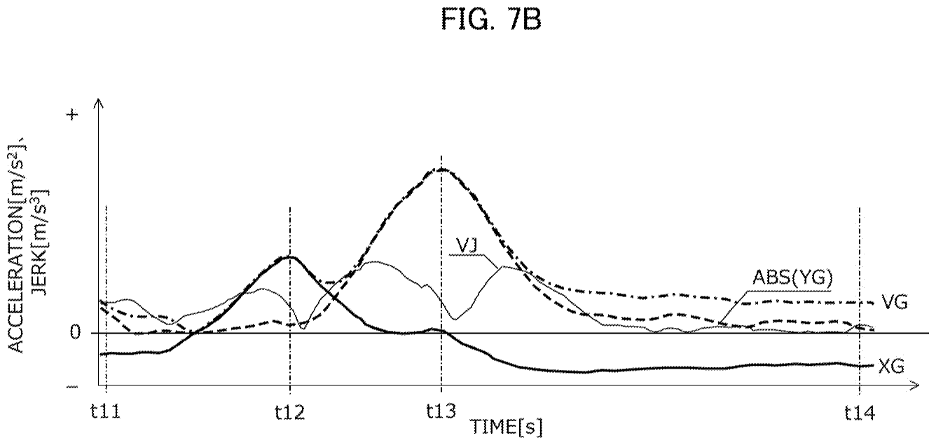

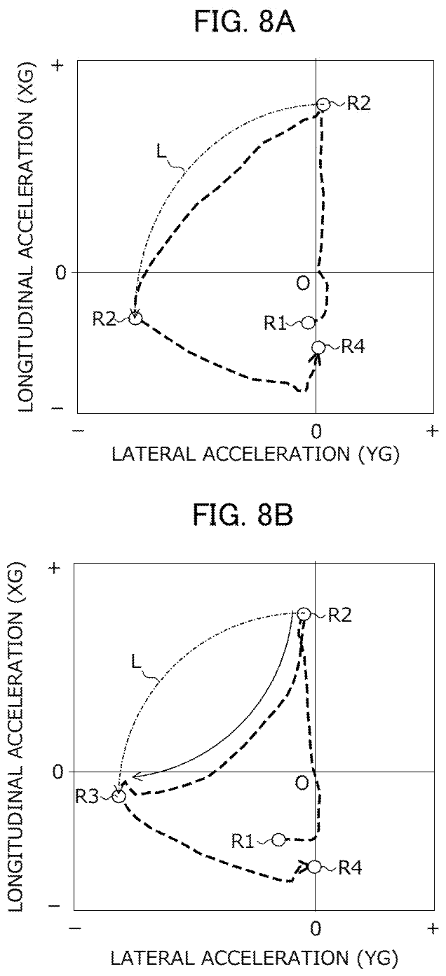

First, procedures for calculating the basic evaluation value PTb in the basic evaluation value calculation unit 54a will be described with reference to FIGS. 7A and 7B, and FIGS. 8A and 8B.

FIGS. 7A and 7B are each a graph illustrating time series data of the longitudinal acceleration value XG and the lateral acceleration value YG included in the in-turn data, and the time series data of the acceleration vector value VG and the jerk vector value VJ that are calculated on the basis of the values XG and YG. More specifically, FIG. 7A illustrates an example of the in-turn data in a case in which a driver is an expert driver, and FIG. 7B illustrates an example of the in-turn data in a case in which the driver is a normal driver.

FIGS. 8A and 8B are each a diagram in which the acceleration vector having the longitudinal acceleration value XG and the lateral acceleration value YG as components and included in the in-turn data of FIGS. 7A and 7B are plotted on a two-dimensional plane with the longitudinal acceleration as the vertical axis and the lateral acceleration as the horizontal axis.

The acceleration vector in the turning scene changes in the order of point R1→point R2→point R3→point R4 illustrated in FIG. 8A and FIG. 8B. It should be noted that point R1, point R2, point R3, and point R4 in FIGS. 8A and 8B respectively correspond to time t11, time t12, time t13, and time t14 in FIGS. 7A and 7B. That is, point R2 in FIGS. 8A and 8B corresponds to time t2 at which the longitudinal acceleration value XG becomes a maximum in the turning scene, and point R3 corresponds to time t3 at which the absolute value ABS(YG) of the lateral acceleration value YG becomes a maximum in the turning scene.

As illustrated in FIGS. 8A and 8B, the shape of the trajectory of the acceleration vector in the turning scenes is substantially triangular in general irrespective of the driving skills of the driver. As is clear from comparing FIG. 8A with FIG. 8B, the driver's driving skills appear in the form of the trajectory of the acceleration vector from point R2 at which the longitudinal acceleration value XG becomes a maximum to point R3 at which the absolute value ABS(YG) of the lateral acceleration becomes a maximum. That is, the trajectory from point R2 to point R3 of the acceleration vector by the expert driver is convex outward from the origin O, more specifically, is close to an elliptic arc L having point R2 as an intersection with the major axis and point R3 as an intersection with the minor axis. On the other hand, as indicated by the thin-line arrow in FIG. 8B, the trajectory from point R2 to point R3 of the acceleration vector by the normal driver becomes concave toward the origin O. That is, the trajectory of the acceleration vector by the normal driver deviates from the elliptic arc L having point R2 as the intersection with the major axis and point R3 as the intersection with the minor axis. From the above, it can be said that the acceleration continuity indicating the stability of the continuity of the acceleration from point R2 at which the longitudinal acceleration becomes a maximum to point R3 at which the absolute value of the lateral acceleration becomes a maximum can be evaluated by comparing the shape of the trajectory of the acceleration vector from point R2 to point R3 with the shape of the elliptic arc L. That is, it can be said that the driving skills in the turning scene are higher as the trajectory of the acceleration vector from point R2 to point R3 is closer to the elliptic arc L.

Therefore, the basic evaluation value calculation unit 54a uses, as a starting point, point R2 at which the longitudinal acceleration value XG among the in-turn data becomes a maximum and, as an ending point, point R3 at which the absolute value of the lateral acceleration value YG is the maximum, and calculates the basic evaluation value PTb on the basis of the comparison between the shape of the trajectory of the time series data of the acceleration vector from the starting point to the ending point and the shape of a predetermined reference trajectory. More specifically, the reference trajectory here adopts an elliptic arc L having a starting point as an intersection point with one of the major axis and the minor axis, and an ending point as an intersection point with the other axis. The basic evaluation value calculating unit 54a obtains the coordinate values of the start point and the end point from the in-turn data, derives an elliptic expression representing the elliptic arc L by using the coordinate values, and calculates the basic evaluation value PTb by quantifying, by a real number between about 0 and about 10 on the basis of a known algorithm, the proximity between the elliptic expression and the trajectory of the acceleration vector from the start point to the end point. That is, the basic evaluation value calculation unit 54a sets the basic evaluation value PTb to a larger value as the trajectory of the acceleration vector approaches the ellipse expression.

Next, procedures for calculating the first demerit point evaluation value PTd1 in the first demerit point evaluation value calculation unit 54b will be described. As illustrated in FIG. 6A, when the longitudinal acceleration is maximized in the vicinity of time t1 and the steering manipulation is started, it is preferable that both the longitudinal acceleration and the lateral acceleration are constant. That is, it can be said that the deceleration stability can be evaluated by the jerk vector value VJ in the vicinity of the time t1.

Therefore, the first demerit point evaluation value calculation unit 54b calculates the time series data of the jerk vector value VJ by using the in-turn data, calculates the minimum value MIN(VJ) of the jerk vector value VJ in the vicinity of time t1 at which the longitudinal acceleration value XG becomes a maximum, and calculates the first demerit point evaluation value PTd1 on the basis of the minimum value MIN(VJ) of the jerk vector. More specifically, the first demerit point evaluation value calculation unit 54b calculates the first demerit point evaluation value PTd1 such that the first demerit point evaluation value PTd1 becomes 0 when the minimum value MIN(VJ) of the jerk vector is 0, and the first demerit point evaluation value PTd1 distances from 0 to become smaller as the minimum value MIN(VJ) of the jerk vector distances from 0. As a result, the first demerit point evaluation value PTd1 of a negative value with 0 as the maximum value and about −1 as the minimum value is calculated.

Next, procedures for calculating the second demerit point evaluation value PTd2 in the second demerit point evaluation value calculation unit 54c will be described. As illustrated in FIG. 6A, when the absolute value ABS(YG) of the lateral acceleration becomes a maximum in the vicinity of the time t2 and transitions to acceleration, it is preferable for the longitudinal acceleration to approach 0. That is, it can be said that the lateral acceleration efficiency can be evaluated by the absolute value ABS(XG) of the longitudinal acceleration at time t2.

Therefore, the second demerit point evaluation value calculation unit 54c calculates the absolute value ABS(XG) of the longitudinal acceleration at the end point at which the absolute value ABS(YG) of the lateral acceleration reaches a maximum by using the in-turn data, and calculates the second demerit point evaluation value PTd2 on the basis of the absolute value ABS(XG) of the longitudinal acceleration. More specifically, the second demerit point evaluation value calculation unit 54c calculates the second demerit point evaluation value PTd2 such that the second demerit point evaluation value PTd2 becomes 0 when the absolute value ABS(XG) of the longitudinal acceleration is 0, and the second demerit point evaluation value PTd2 distances from 0 and becomes smaller as the absolute value ABS(XG) of the longitudinal acceleration distances from 0. As a result, the second demerit point evaluation value PTd2 having a negative value with 0 as the maximum value and about −1 as the minimum value is calculated.

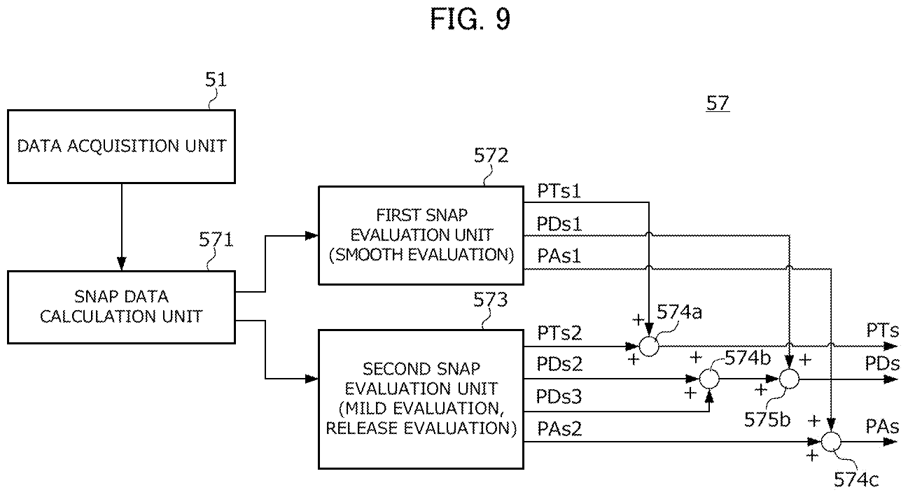

Next, with reference to FIG. 9, a procedure for evaluating the driving skills of a driver by using acceleration and snap in the snap evaluation unit 57 is described.

FIG. 9 is a diagram of a configuration of the snap evaluation unit 57. The snap evaluation unit 57 calculates time series data of snap on the basis of the traveling data of each traveling scene (in-turn data, in-deceleration data, and in-acceleration data) acquired by the data acquisition unit 51, and evaluates driving skills in each traveling scene on the basis of time series data of snap in an evaluation target period which is a transitional period of acceleration in a recording period of each traveling scene. More specifically, the snap evaluation unit 57 calculates the driving skills in each traveling scene with snap evaluation values PTs, PDs, and PAs which are quantified with a real number equal to or less than 0. In other words, as illustrated in FIG. 4, the snap evaluation unit 57 evaluates the driving skills according to a demerit point system. The snap evaluation unit 57 calculates the driving skills in the turning scene as a snap evaluation value PTs, calculates the driving skills in the deceleration scene as a snap evaluation value PDs, and calculates the driving skills in the acceleration scene as a snap evaluation value PAs.

More specifically, the snap evaluation unit 57 includes: a snap data calculation unit 571 that calculates snap data which is snap time series data in each traveling scene by using traveling data of each traveling scene (in-turn data, in-deceleration data, and in-acceleration data) acquired by the data acquisition unit 51; a first snap evaluation unit 572 that calculates evaluation values PTs1, PDs1, and PAs1 in each traveling scene on the basis of the number of times the snap crosses the value of 0; a second snap evaluation unit 573 that calculates evaluation values PTs2, PDs2, PDs3, and PAs2 in each traveling scene on the basis of a maximum value of an absolute value of the snap; and a summing unit 574a, 574b, and 574c that calculates the snap evaluation values PTs, PDs, and PAs in each traveling scene by summing the evaluation values PTs1, PDs1, and PAs1 and the evaluation values PTs2, PDs2, PDs3, and PAs2.

The snap data calculation unit 571 performs second-order time differential on the time series data of longitudinal acceleration and lateral acceleration included in the traveling data of each traveling scene acquired by the data acquisition unit 51, thereby calculating snap data which is time series data of longitudinal snap and lateral snap. In the following, a value of the longitudinal span calculated by the snap data calculation unit 571 is denoted as XS, and a value of the lateral snap calculated by the snap data calculation unit 571 is denoted as YS.

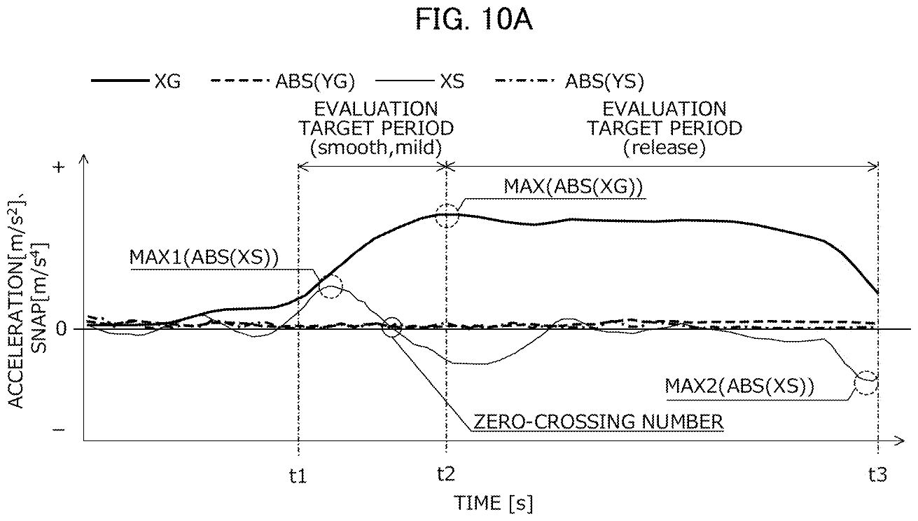

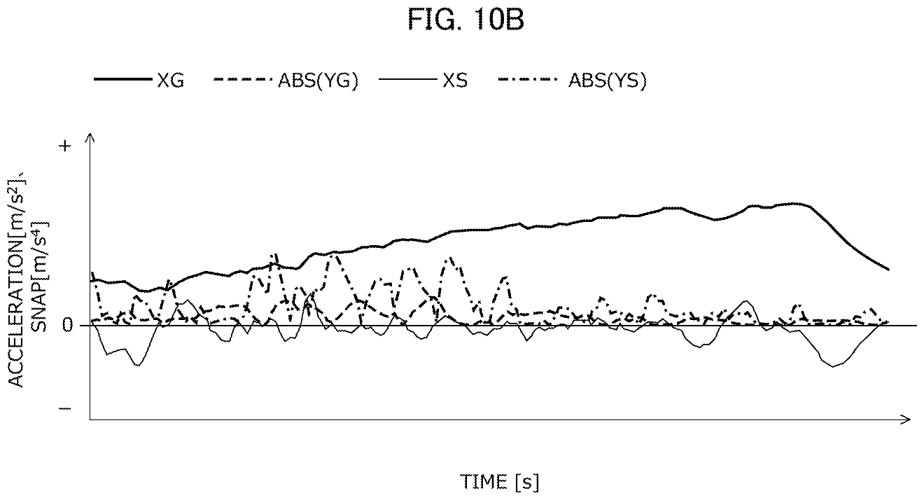

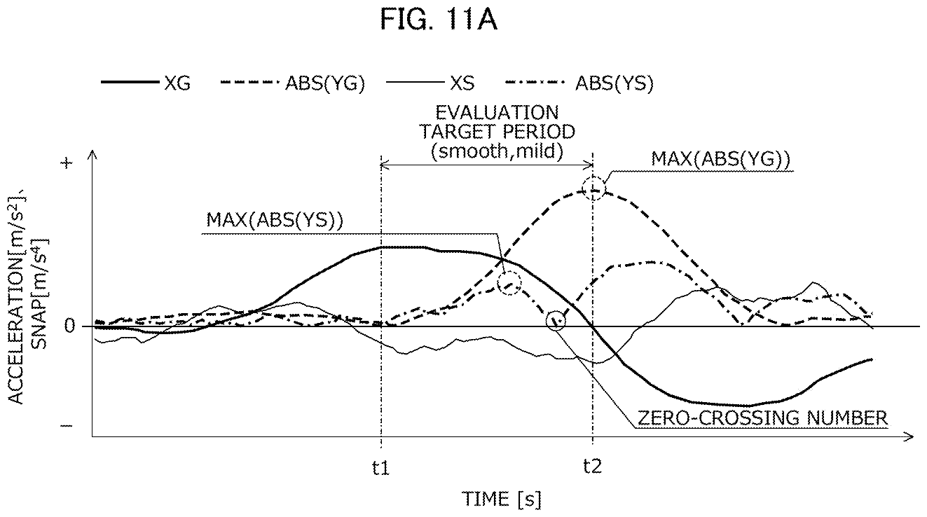

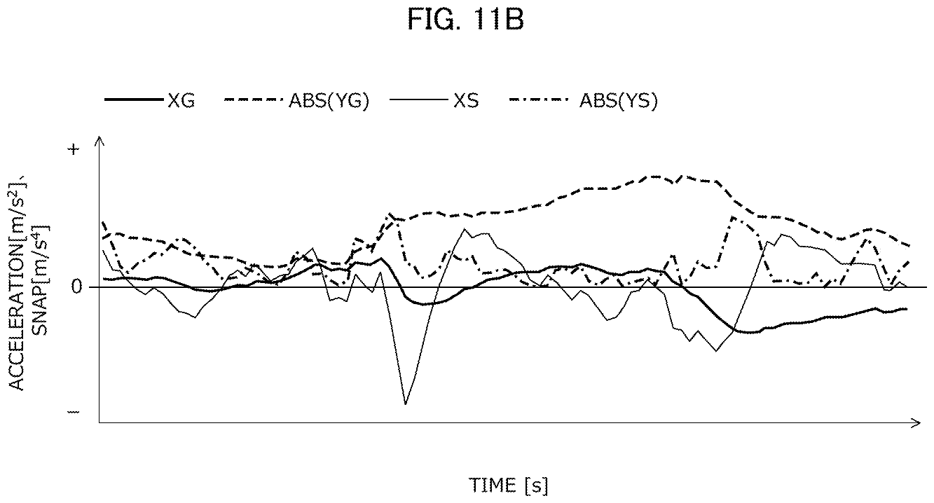

In the following, specific evaluation procedures in the first snap evaluation unit 572 and the second snap evaluation unit 573 are described with reference to FIGS. 10A and 10B, and FIGS. 11A and 11B.

FIGS. 10A and 10B are each a graph illustrating an example of time series data of a value XS of longitudinal snap and an absolute value ABS(YS) of a value YS of lateral snap included in the snap data of the deceleration scene. Further, FIGS. 11A and 11B are each a graph illustrating an example of time series data of a value XS of longitudinal snap and a value YS of lateral snap included in the snap data of turning scene. It should be noted that, in FIGS. 10A and 10B and FIGS. 11A and 11B, the longitudinal acceleration value XG, the absolute value of the lateral acceleration ABS(YG), and the jerk vector value VJ are illustrated in a superimposed manner, for reference. In addition, FIGS. 10A and 11A each illustrate an example of time series data in a case in which a driver is an expert driver, and FIGS. 10B and 11B each illustrates an example of time series data in a case in which a driver is a normal driver.

The first snap evaluation unit 572 sets, in accordance with the kind of traveling scene, an evaluation target period which is a transitional period of acceleration in the recording period of the snap data calculated for each traveling data by the snap data calculation unit 571, and evaluates the driving skills on the basis of the number of times the snap crosses the value of 0 within the evaluation target period. It should be noted that the driving evaluation in the first snap evaluation unit 572 is also referred to as smooth evaluation.

The first snap evaluation unit 572 sets the evaluation target period in which the smooth evaluation is performed, as described below in accordance with the kind of traveling scene. First, as illustrated in FIG. 10A, in a case in which the traveling scene is a deceleration scene or an acceleration scene, the first snap evaluation unit 572 sets a period from the starting time period of the traveling data (in the example of FIG. 10A, time t1) to the time period in which the absolute value ABS(XG) of the longitudinal acceleration becomes a maximum (in the example of FIG. 10A, time t2) as an evaluation target period of the smooth evaluation. Further, as illustrated in FIG. 11A, in a case in which the traveling scene is a turning scene, the first snap evaluation unit 572 sets a period from the time period in which the absolute value ABS(XG) of the longitudinal acceleration becomes a maximum (in the example of FIG. 11A, time t1) to the time period in which the absolute value ABS(YG) of the lateral acceleration becomes a maximum (in the example of FIG. 11A, time t2) as an evaluation target period of the smooth evaluation.

The first snap evaluation unit 572 sets the evaluation target period in accordance with the kind of traveling scene as described above, and thereafter, calculates the evaluation values PTs1, PDs1, and PAs1 in each traveling scene as described below.

In a case in which the traveling scene is a deceleration scene, the first snap evaluation unit 572 calculates a zero-crossing number which is a number of times the value XS of longitudinal snap crosses the value of 0 within the evaluation target period, and calculates the evaluation value PDs1 in such a way that the evaluation value PDs1 becomes smaller as the zero-crossing number becomes larger. More specifically, in a case in which the zero-crossing number is 0 or 1, the first snap evaluation unit 572 sets the evaluation value PDs1 to 0. Further, in a case in which the zero-crossing number is equal to or more than 2, the first snap evaluation unit 572 calculates the evaluation value PDs1 by subtracting, by the value of 10, the value arrived at by subtracting the value 1 from the zero-crossing number.

It should be noted that, in the example of FIG. 10A, since the number of the zero-crossing number is 1, the evaluation value PDs1 is 0. Further, in the example of FIG. 10B, since the zero-crossing number is 8, the evaluation value PDs1 is −0.7. As illustrated in FIG. 10B, a normal driver tends to manipulate the brake pedal gently in the deceleration scene, and it tends to take a long time until reaching the target acceleration. Therefore, there is a tendency for the zero-crossing number to become more for a normal driver than an expert driver. With the smooth evaluation by the first snap evaluation unit 572, it is possible to appropriately evaluate the driving skills in a transitional period of acceleration in the deceleration scene.

Similarly to a case in which the traveling scene is an acceleration scene, the first snap evaluation unit 572 calculates the zero-crossing number which is the number of times the value XS of the longitudinal snap crosses the value of 0 within the evaluation target period, and calculates the evaluation value PAs1 in such a manner that the evaluation value PAs1 becomes smaller as the zero-crossing number becomes larger. More specifically, in a case in which the zero-crossing number is 0 or 1, the first snap evaluation unit 572 sets the evaluation value PAs1 to 0. Further, in a case in which the zero-crossing number is equal to or more than 2, the first snap evaluation unit 572 calculates the evaluation value PAs1 by subtracting, by the value of 10, the value arrived at by subtracting the value 1 from the zero-crossing number.

Further, in a case in which the traveling scene is a turning scene, the first snap evaluation unit 572 calculates a zero-crossing number which is a number of times the lateral snap value YS crosses the value of 0 within the evaluation target period, and calculates the evaluation value PTs1 in such a way that the evaluation value PTs1 becomes smaller as the zero-crossing number becomes larger. More specifically, in a case in which the zero-crossing number is 0 or 1, the first snap evaluation unit 572 sets the evaluation value PTs1 to 0. Further, in a case in which the zero-crossing number is equal to or more than 2, the first snap evaluation unit 572 calculates the evaluation value PTs1 by subtracting, by the value of 10, the value arrived at by subtracting the value 1 from the zero-crossing number.

It should be noted that, in the example of FIG. 11A, since the number of the zero-crossing number is 0, the evaluation value PTs1 is 0. Further, in the example of FIG. 11B, since the zero-crossing number is 6, the evaluation value PTs1 is −0.5. In this way, with the smooth evaluation by the first snap evaluation unit 572, it is possible to appropriately evaluate the driving skills in a transitional period of acceleration even in the turning scene.

The second snap evaluation unit 573 sets, in accordance with the kind of traveling scene, an evaluation target period which is a transitional period of acceleration in the recording period of the snap data calculated for each traveling scene by the snap data calculation unit 571, and evaluates the driving skills on the basis of the maximum value of an absolute value of the snap within the evaluation target period. It should be noted that the driving evaluation in the second snap evaluation unit 573 is also referred to as mild evaluation or release evaluation. It should be noted that the difference between this mild evaluation and release evaluation will be described later.

The second snap evaluation unit 573 sets the evaluation target period in which the mild evaluation and the release evaluation are performed, as described below in accordance with the kind of traveling scene. First, as illustrated in FIG. 10A, in a case in which the traveling scene is a deceleration scene, the second snap evaluation unit 573 sets a period from the starting time period of the traveling data (in the example of FIG. 10A, time t1) to the time period in which the absolute value ABS(XG) of the longitudinal acceleration becomes a maximum (in the example of FIG. 10A, time t2) as an evaluation target period of the mild evaluation. Furthermore, the second snap evaluation unit 573 sets a period from a final period of the evaluation target period of the mild evaluation (in the example of FIG. 10A, time t2) to an ending period of the traveling data (in the example of FIG. 10A, time t3) as an evaluation target period of the release evaluation. In other words, in a case in which the traveling scene is a deceleration scene, the evaluation target period of the mild evaluation is the same as the evaluation target period of the smooth evaluation. Further, the mild evaluation and the release evaluation use the same evaluation algorithm, but differ from each other in the evaluation target period. In a case in which the traveling scene is a deceleration scene, the transitional period of acceleration appears at two times when starting deceleration (when starting to depress the brake pedal) and when ending the deceleration (when releasing the depression of the brake pedal). Therefore, in a case in which the traveling scene is a deceleration scene, the second snap evaluation unit 573 sets two evaluation target periods.

In a case in which the traveling scene is an acceleration scene, the second snap evaluation unit 573 sets a period from the starting time period of the traveling data to the time period in which the absolute value of the longitudinal acceleration ABS(XG) becomes a maximum as the evaluation target period of the mild evaluation. In other words, in a case in which the traveling scene is an acceleration scene, the evaluation target period of the mild evaluation is the same as the evaluation target period of the smooth evaluation. Further, in a case in which the traveling scene is an acceleration scene, the second snap evaluation unit 573 does not perform release evaluation.

Further, as illustrated in FIG. 11A, in a case in which the traveling scene is a deceleration scene, the second snap evaluation unit 573 sets a period from the time period in which the absolute value ABS(XG) of the longitudinal acceleration becomes a maximum (in the example of FIG. 11A, time t1) to the time period in which the absolute value ABS(YG) of the lateral acceleration becomes a maximum (in the example of FIG. 11A, time t2) as an evaluation target period of the mild evaluation. In other words, in a case in which the traveling scene is a turning scene, the evaluation target period of the mild evaluation is the same as the evaluation target period of the smooth evaluation. Further, in a case in which the traveling scene is an acceleration scene, the second snap evaluation unit 573 does not perform release evaluation. As described above, the second snap evaluation unit 573 performs release evaluation only when the traveling scene is a deceleration scene.

The second snap evaluation unit 573 sets the evaluation target period in accordance with the kind of traveling scene as described above, and thereafter, calculates the evaluation values PTs2, PDs2, PDs3, and PAs2 in each traveling scene as described below. More specifically, the second snap evaluation unit 573 includes an acceleration prediction model defined for each traveling scene, and calculates the evaluation values PTs2, PDs2, PDs3, and PAs2 by using the acceleration prediction models and a maximum value of an absolute value of snap within an evaluation target period.

Here, acceleration prediction model refers to a mathematical model which outputs the maximum value of the absolute value of the snap within the evaluation target period in a case of inputting the maximum value of the absolute value of the snap within the evaluation target period and the maximum vehicle speed within the same evaluation target period. The second snap evaluation unit 573 includes, as the acceleration prediction model described above, an in-braking prediction model, an off-braking prediction model, an in-accelerating prediction model, and an in-turn prediction model.

The in-braking prediction model refers to a mathematical model that outputs a prediction value for the maximum value of the absolute value of the longitudinal acceleration within the evaluation target period in a case of inputting the maximum value of the absolute value of the longitudinal snap within the evaluation target period of the mild evaluation in the deceleration scene and the maximum vehicle speed within the same evaluation target period. For such a mathematical model, a linear regression model is used which is constructed by using a plurality of pieces of traveling data that have been evaluated as high in the smooth evaluation by the abovementioned first snap evaluation unit 572 (in particular, traveling data having the evaluation value of 0), for example. Since there is a correlation among the maximum value of the absolute value of the longitudinal snap within the evaluation target period, the maximum vehicle speed, and the maximum value of the absolute value of the longitudinal acceleration, it is possible to construct such a linear regression model by performing a test in advance.

The off-braking prediction model refers to a mathematical model that outputs a prediction value for the maximum value of the absolute value of the longitudinal acceleration within this evaluation target period in a case of inputting the maximum value of the absolute value of the longitudinal snap within the evaluation target period of the release evaluation in the deceleration scene and the maximum vehicle speed within the same evaluation target period. For such a mathematical model, a linear regression model is used which is constructed by a procedure similarly to that for the in-braking prediction model.

The in-accelerating prediction model refers to a mathematical model that outputs a prediction value for the maximum value of the absolute value of the longitudinal acceleration within the evaluation target period in a case of inputting the maximum value of the absolute value of the longitudinal snap within the evaluation target period of the mild evaluation in the acceleration scene and the maximum vehicle speed within the same evaluation target period. For such a mathematical model, a linear regression model is used which is constructed by a procedure similarly to that for the in-braking prediction model.

The in-turn prediction model refers to a mathematical model that outputs a prediction value for the maximum value of the absolute value of the lateral acceleration within the evaluation target period in a case of inputting the maximum value of the absolute value of the lateral snap within the evaluation target period of the mild evaluation in the turning scene and the maximum vehicle speed within the same evaluation target period. For such a mathematical model, a linear regression model is used which is constructed by a procedure similarly to that for the in-braking prediction model.

In a case in which the traveling scene is a deceleration scene, initially as illustrated in FIG. 10A, the second snap evaluation unit 573 calculates the maximum value MAX1(ABS(XS)) of the absolute value ABS(XS) of the longitudinal snap within the evaluation target period of the mild evaluation, and the maximum value MAX2(ABS(XS)) of the absolute value ABS(XS) of the longitudinal snap within the evaluation target period of the release evaluation. Further, the second snap evaluation unit 573 calculates a prediction value for the absolute value of the longitudinal acceleration within this evaluation target period by inputting the maximum value MAX1(ABS(XS)) and the maximum vehicle speed within the evaluation target period of the mild evaluation into the in-braking prediction model, and calculates the evaluation value PDs2 by calculating the degree of divergence between the maximum value MAX(ABS(XG)) of the absolute value of the longitudinal acceleration within the same evaluation target period and the prediction value. More specifically, the second snap evaluation unit 573 calculates the degree of divergence by subtracting the prediction value from the maximum value MAX(ABS(XG)) of the absolute value of the longitudinal acceleration, and sets the evaluation value PDs2 to the value of 0 in a case in which the degree of divergence is equal to or more than 0, and sets the evaluation value PDs2 to the degree of divergence of a negative value in a case in which the degree of divergence is less than 0 (mild evaluation).

The second snap evaluation unit 573 calculates a prediction value for the absolute value of the longitudinal acceleration within this evaluation target period by inputting the maximum value MAX2(ABS(XS)) and the maximum vehicle speed within the evaluation target period of the release evaluation into the in-braking prediction model, and calculates the evaluation value PDs3 by calculating degree of divergence between the maximum value MAX(ABS(XG)) of the absolute value of the longitudinal acceleration within the same evaluation target period and the prediction value. More specifically, the second snap evaluation unit 573 calculates the degree of divergence by subtracting the prediction value from the maximum value MAX(ABS(XG)) of the absolute value of the longitudinal acceleration, and sets the evaluation value PDs3 to the value of 0 in a case in which the degree of divergence is equal to or more than 0, and sets the evaluation value PDs3 to the degree of divergence of a negative value in a case in which the degree of divergence is less than 0 (release evaluation).

In a case in which the traveling scene is an acceleration scene, the second snap evaluation unit 573 initially calculates the maximum value MAX(ABS(XS)) of the absolute value ABS(XS) of the longitudinal snap within the evaluation target period of the mild evaluation. Further, the second snap evaluation unit 573 calculates a prediction value for the absolute value of the longitudinal acceleration within this evaluation target period by inputting the maximum value MAX(ABS(XS)) and the maximum vehicle speed within the evaluation target period of the mild evaluation into the in-accelerating prediction model, and calculates the snap evaluation value PAs2 in the acceleration scene by calculating the degree of divergence between the maximum value of the absolute value of the longitudinal acceleration within the same evaluation target period and this prediction value (mild evaluation). More specifically, the second snap evaluation unit 573 calculates the degree of divergence by subtracting the prediction value from the maximum value of the absolute value of the longitudinal acceleration, and sets the evaluation value PAs2 to the value of 0 in a case in which the degree of divergence is equal to or more than 0, and sets the evaluation value PAs2 to the degree of divergence of a negative value in a case in which the degree of divergence is less than 0.

Further, as illustrated in FIG. 11A, in a case in which the traveling scene is a turning scene, the second snap evaluation unit 573 initially calculates the maximum value MAX(ABS(YS)) of the absolute value ABS(YS) of the lateral snap within the evaluation target period of the mild evaluation. Further, the second snap evaluation unit 573 calculates a prediction value for the absolute value of the lateral acceleration within this evaluation target period by inputting the maximum value MAX(ABS(YS)) and the maximum vehicle speed within the evaluation target period of the mild evaluation into the in-turn prediction model, and calculates the snap evaluation value PTs2 in the turning scene by calculating the degree of divergence between the maximum value MAX(ABS(YG)) of the absolute value of the lateral acceleration within the same evaluation target period and this prediction value (mild evaluation). More specifically, the second snap evaluation unit 573 calculates the degree of divergence by subtracting the prediction value from the maximum value MAX(ABS(YG)) of the absolute value of the longitudinal acceleration, and sets the evaluation value PTs2 to the value of 0 in a case in which the degree of divergence is equal to or more than 0, and sets the evaluation value PTs2 to the degree of divergence of a negative value in a case in which the degree of divergence is less than 0.

The summing unit 574a calculates the snap evaluation value PTs by summing the evaluation value PTs1 calculated by the first snap evaluation unit 572 and the evaluation value PTs2 calculated by the second snap evaluation unit 573. The summing units 574b and 575b calculate the snap evaluation value PDs by summing the evaluation value PDs1 calculated by the first snap evaluation unit 572 and the evaluation values PDs2 and PDs3 calculated by the second snap evaluation unit 573. The summing unit 574c calculates the snap evaluation value PAs by summing the evaluation value PAs1 calculated by the first snap evaluation unit 572 and the evaluation value PAs2 calculated by the second snap evaluation unit 573.

With reference to FIG. 1 again, the comprehensive evaluation units 58a, 58b, and 58c calculate the driving evaluation values PT, PD, and PA in each traveling scene by using the basic evaluation values PTb, PDb, and PAb of each traveling scene calculated by the acceleration/jerk evaluation unit 53 and the demerit point evaluation values PTd1 and PTd2, and the snap evaluation values PTs, PDs, and PAs of each traveling scene calculated by the snap evaluation unit 57. More specifically, the comprehensive evaluation unit 58a calculates the driving evaluation value PT in the turning scene by summing the basic evaluation value PTb, the first demerit point evaluation value PTd1, the second demerit point evaluation value PTd2, and the snap evaluation value PTs, the comprehensive evaluation unit 58b calculates the driving evaluation value PD in the deceleration scene by summing the basic evaluation value PDb and the snap evaluation value PDs, the comprehensive evaluation unit 58c calculates the driving evaluation value PA in the acceleration scene by summing the basic evaluation value PAb and the snap evaluation value PAs, and displays each evaluation value on the display unit 6.

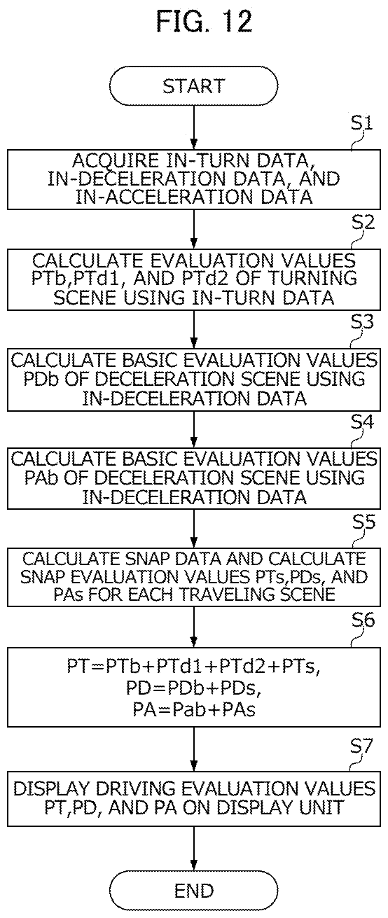

FIG. 12 is a flowchart illustrating a specific procedure for evaluating driving skills of a driver in the driving evaluation system 1. The processing illustrated in FIG. 12 may be performed in real time during traveling of the vehicle V, or may be performed after traveling of the vehicle V.

First, in S1, the data acquisition unit 51 acquires the in-turn data, the in-deceleration data, and the in-acceleration data. More specifically, the scene extraction unit 51a extracts, as evaluation target data, time series data that satisfy the above conditions (a), (b), and (c) from among time series data of the longitudinal acceleration and the lateral acceleration obtained from the longitudinal acceleration sensor 2 and the lateral acceleration sensor 3 through the filter 51f while the vehicle V is traveling. The in-turn data acquisition unit 51b acquires the in-turn data including time series data of longitudinal acceleration and lateral acceleration in the turning scene from among the evaluation target data. The in-deceleration data acquisition unit 51c acquires the in-deceleration data including time series data of the longitudinal acceleration and the lateral acceleration in the deceleration scene from among the evaluation target data excluding the in-turn data. In addition, the in-acceleration data acquisition unit 51d acquires the in-acceleration data including time series data of the longitudinal acceleration and the lateral acceleration in the acceleration scene by excluding the in-turn data and the in-deceleration data from the evaluation target data.

Next, in S2, the turning scene evaluation unit 54 calculates the evaluation values PTb, PTd1, and PTd2 in which the driver's driving skills in the turning scene are quantified on the basis of the in-turn data acquired in S1. More specifically, the basic evaluation value calculation unit 54a calculates the basic evaluation value PTb on the basis of the comparison between the shape of the trajectory of the time series data of the acceleration vector from the start point at which the longitudinal acceleration becomes a maximum to the end point at which the absolute value of the lateral acceleration becomes a maximum among the in-turn data, and the shape of the reference trajectory. The first demerit point evaluation value calculation unit 54b calculates a minimum value of the jerk vector in the vicinity of the time at which the longitudinal acceleration becomes a maximum by using the in-turn data, and calculates the first demerit point evaluation value PTd1 on the basis of the minimum value of the jerk vector. The second demerit point evaluation value calculation unit 54c calculates the absolute value of the longitudinal acceleration at the end point at which the absolute value of the lateral acceleration reaches a maximum by using the in-turn data, and calculates the second demerit point evaluation value PTd2 on the basis of the absolute value of the longitudinal acceleration. Further, the summing unit 54d sums these evaluation values PTb, PTd1, and PTd2.

Next, in S3, the deceleration scene evaluation unit 55 calculates, on the basis of the deceleration time data acquired in S1, a basic evaluation value PDb in which the driver's driving skills in the deceleration scene are quantified. More specifically, the deceleration scene evaluation unit 55 calculates the basic evaluation value PDb by using the average value and the maximum value of the jerk vector over the recording time of the in-deceleration data.

Next, in S4, the acceleration scene evaluation unit 56 calculates, on the basis of the in-acceleration data acquired in S1, the basic evaluation value PAb in which the driver's driving skills in the acceleration scene are quantified. More specifically, the acceleration scene evaluation unit 56 calculates the basic evaluation value PAb by using the average value and the maximum value of the jerk vector over the recording time of the in-acceleration data.

Next, in S5, the snap evaluation unit 57 calculates the snap evaluation values PTs, PDs, and PAs for each traveling scene on the basis of the traveling data of each traveling scene acquired by the data acquisition unit 51. More specifically, the snap data calculation unit 571 performs second-order time differential on the time series data of longitudinal acceleration and lateral acceleration included in the traveling data of each traveling scene acquired by the data acquisition unit 51, thereby calculating snap data which is time series data of longitudinal snap and lateral snap.

The first snap evaluation unit 572 sets an evaluation target period for each traveling scene, performs the smooth evaluation on the basis of the snap data in this evaluation target period, and calculates the evaluation values PTs1, PDs1, and PAs1 for each traveling scene. Further, the second snap evaluation unit 573 sets an evaluation target period for each traveling scene, performs the mild evaluation and the release evaluation on the basis of the snap data in this evaluation target period, and calculates the evaluation values PTs2, PDs2, PDs3, and PAs2 for each traveling scene. Further, the summing units 574a, 574b, 575b, and 574c calculate the snap evaluation values PTs, PDs, and PAs in each traveling scene by respectively summing these evaluation values PTs1, PDs1, and PAs1, and the evaluation values PTs2, PDs2, PDs3, and PAs2.

Next, in S6, the comprehensive evaluation units 58a, 58b, and 58c calculate the driving evaluation values PT, PD, and PA for each traveling scene by respectively summing the basic evaluation values PTb, PDb, and PAb calculated as described above, the demerit point evaluation values, PTd1 and PTd2, and the snap evaluation values PTs, PDs, and PAs.

Next, in S7, the ECU 5 displays the driving evaluation values PT, PD, and PA on the display unit 6.

Although an embodiment of the present invention has been described above, the present invention is not limited thereto. For example, in the embodiment described above, a case is described in which the driving evaluation system 1 is configured by combining the longitudinal acceleration sensor 2, the lateral acceleration sensor 3, the ECU 5, and the display unit 6 equipped to the vehicle V; however, the present invention is not limited to thereto. The driving evaluation system may be configured by a portable terminal such as a smartphone including a longitudinal acceleration sensor, a lateral acceleration sensor, a computer, and a display unit.

What is claimed is:

1. A driving evaluation system that evaluates driving skills of a vehicle by a driver, the system comprising:
a data acquisition unit that is configured to acquire traveling data including time series data of acceleration in a predetermined traveling scene; and
an evaluation unit that is configured to calculate, on a basis of the traveling data, time series data of snap which is second-order time differential of acceleration, and evaluate driving skills in the traveling scene on a basis of time series data of snap in an evaluation target period which is a transitional period of acceleration in a recording period of the traveling data.

2. The driving evaluation system according to claim 1, wherein the evaluation unit includes a first evaluation unit that evaluates driving skills on a basis of a number of times the snap crosses a value of 0 within the evaluation target period.

3. The driving evaluation system according to claim 2, wherein the traveling data includes time series data of longitudinal acceleration and time series data of lateral acceleration; and the first evaluation unit
sets, in a case in which the traveling scene is a deceleration scene or an acceleration scene, a period from a starting time period of the traveling data to a time period in which an absolute value of longitudinal acceleration becomes a maximum, as the evaluation target period, and
sets, in a case in which the traveling scene is a turning scene, a period from a time period in which an absolute value of longitudinal acceleration becomes a maximum to a time period in which an absolute value of lateral acceleration becomes a maximum, as the evaluation target period.

4. The driving evaluation system according to claim 1, wherein the evaluation unit includes a second evaluation unit that evaluates driving skills on a basis of a maximum value of an absolute value of snap within the evaluation target period.

5. The driving evaluation system according to claim 2, wherein the evaluation unit includes a second evaluation unit that evaluates driving skills on a basis of a maximum value of an absolute value of snap within the evaluation target period.

6. The driving evaluation system according to claim 3, wherein the evaluation unit includes a second evaluation unit that evaluates driving skills on a basis of a maximum value of an absolute value of snap within the evaluation target period.

7. The driving evaluation system according to claim 4, further comprising:
an acceleration prediction model that is configured to output a prediction value for a maximum value of an absolute value of acceleration within the evaluation target period when inputting a maximum value of an absolute value of snap within the evaluation target period, wherein
the second evaluation unit evaluates driving skills on a basis of degree of divergence between the maximum value of the absolute value of acceleration within the evaluation target period and a prediction value calculated by using the acceleration prediction model.

8. The driving evaluation system according to claim 5, further comprising:
an acceleration prediction model that is configured to output a prediction value for a maximum value of an absolute value of acceleration within the evaluation target period when inputting a maximum value of an absolute value of snap within the evaluation target period, wherein
the second evaluation unit evaluates driving skills on a basis of degree of divergence between the maximum value of the absolute value of acceleration within the evaluation target period and a prediction value calculated by using the acceleration prediction model.

9. The driving evaluation system according to claim 6, further comprising:
an acceleration prediction model that is configured to output a prediction value for a maximum value of an absolute value of acceleration within the evaluation target period when inputting a maximum value of an absolute value of snap within the evaluation target period, wherein
the second evaluation unit evaluates driving skills on a basis of degree of divergence between the maximum value of the absolute value of acceleration within the evaluation target period and a prediction value calculated by using the acceleration prediction model.

10. The driving evaluation system according to claim 4, wherein
the traveling data includes time series data of longitudinal acceleration and time series data of lateral acceleration, and
the second evaluation unit:
sets as the evaluation target period, in a case in which the traveling scene is a deceleration scene, a first period from a starting time period of the traveling data to a time period in which an absolute value of longitudinal acceleration becomes a maximum and a second period from a final period of the first period to an ending time period of the traveling data, and evaluates driving skills for each of the first period and the second period;
sets as the evaluation target period, in a case in which the traveling scene is an acceleration scene, the first period; and
sets as the evaluation target period, in a case in which the traveling scene is a turning scene, a period from a time period in which an absolute value of longitudinal acceleration becomes a maximum to a time period in which an absolute value of lateral acceleration becomes a maximum.

11. The driving evaluation system according to claim 5, wherein
the traveling data includes time series data of longitudinal acceleration and time series data of lateral acceleration, and
the second evaluation unit:
sets as the evaluation target period, in a case in which the traveling scene is a deceleration scene, a first period from a starting time period of the traveling data to a time period in which an absolute value of longitudinal acceleration becomes a maximum and a second period from a final period of the first period to an ending time period of the traveling data, and evaluates driving skills for each of the first period and the second period;
sets as the evaluation target period, in a case in which the traveling scene is an acceleration scene, the first period; and
sets as the evaluation target period, in a case in which the traveling scene is a turning scene, a period from a time period in which an absolute value of longitudinal acceleration becomes a maximum to a time period in which an absolute value of lateral acceleration becomes a maximum.

12. The driving evaluation system according to claim 6, wherein
the traveling data includes time series data of longitudinal acceleration and time series data of lateral acceleration, and
the second evaluation unit:
sets as the evaluation target period, in a case in which the traveling scene is a deceleration scene, a first period from a starting time period of the traveling data to a time period in which an absolute value of longitudinal acceleration becomes a maximum and a second period from a final period of the first period to an ending time period of the traveling data, and evaluates driving skills for each of the first period and the second period;
sets as the evaluation target period, in a case in which the traveling scene is an acceleration scene, the first period; and
sets as the evaluation target period, in a case in which the traveling scene is a turning scene, a period from a time period in which an absolute value of longitudinal acceleration becomes a maximum to a time period in which an absolute value of lateral acceleration becomes a maximum.

13. The driving evaluation system according to claim 7, wherein
the traveling data includes time series data of longitudinal acceleration and time series data of lateral acceleration, and
the second evaluation unit:
sets as the evaluation target period, in a case in which the traveling scene is a deceleration scene, a first period from a starting time period of the traveling data to a time period in which an absolute value of longitudinal acceleration becomes a maximum and a second period from a final period of the first period to an ending time period of the traveling data, and evaluates driving skills for each of the first period and the second period;
sets as the evaluation target period, in a case in which the traveling scene is an acceleration scene, the first period; and
sets as the evaluation target period, in a case in which the traveling scene is a turning scene, a period from a time period in which an absolute value of longitudinal acceleration becomes a maximum to a time period in which an absolute value of lateral acceleration becomes a maximum.

14. The driving evaluation system according to claim 8, wherein
the traveling data includes time series data of longitudinal acceleration and time series data of lateral acceleration, and
the second evaluation unit:
sets as the evaluation target period, in a case in which the traveling scene is a deceleration scene, a first period from a starting time period of the traveling data to a time period in which an absolute value of longitudinal acceleration becomes a maximum and a second period from a final period of the first period to an ending time period of the traveling data, and evaluates driving skills for each of the first period and the second period;
sets as the evaluation target period, in a case in which the traveling scene is an acceleration scene, the first period; and
sets as the evaluation target period, in a case in which the traveling scene is a turning scene, a period from a time period in which an absolute value of longitudinal acceleration becomes a maximum to a time period in which an absolute value of lateral acceleration becomes a maximum.

15. The driving evaluation system according to claim 9, wherein
the traveling data includes time series data of longitudinal acceleration and time series data of lateral acceleration, and
the second evaluation unit:
sets as the evaluation target period, in a case in which the traveling scene is a deceleration scene, a first period from a starting time period of the traveling data to a time period in which an absolute value of longitudinal acceleration becomes a maximum and a second period from a final period of the first period to an ending time period of the traveling data, and evaluates driving skills for each of the first period and the second period;
sets as the evaluation target period, in a case in which the traveling scene is an acceleration scene, the first period; and
sets as the evaluation target period, in a case in which the traveling scene is a turning scene, a period from a time period in which an absolute value of longitudinal acceleration becomes a maximum to a time period in which an absolute value of lateral acceleration becomes a maximum.

16. A driving evaluation method executed by a driving evaluation system according to claim 1, the method comprising the steps of:
acquiring, by way of the data acquisition unit, traveling data including time series data of acceleration in a predetermined traveling scene; and
evaluating, by way of the evaluation unit, driving skills in the traveling scene on a basis of time series data of snap in an evaluation target period which is a transitional period of acceleration in a recording period of the traveling data, while calculating, on a basis of the traveling data, time series data of snap which is second-order time differential of acceleration.

17. A program for causing a computer to execute each step of the driving evaluation method according to claim 16.

18. A medium encoded with the program according to claim 17.
